(19) United States
(12) Patent Application Publication
(10) Pub. No.: US 2025/0299392 A1
(43) Pub. Date: Sep. 25, 2025

(54) LABEL HISTOGRAM CREATING DEVICE, LABEL HISTOGRAM CREATING METHOD AND LABEL HISTOGRAM CREATING PROGRAM

(71) Applicant: Nippon Telegraph and Telephone Corporation, Tokyo (JP)

(72) Inventor: Hidetoshi Kawaguchi, Musashino-shi, Tokyo (JP)

(21) Appl. No.: 18/863,375

(22) PCT Filed: May 18, 2022
(86) PCT No.: PCT/JP2022/020726

§ 371 Date: Nov. 6, 2024

(51) Int. Cl. G06T 11/20

(52) U.S. Cl. CPC G06T 11/206

(57) ABSTRACT

A label histogram creating part (14) of a label histogram creating device (1) sets the number of times of sampling (β) for each piece of data (x) for a data set (X) including N pieces of data (x) and performs a first sampling process on the data set (X) by using a crowdsourcing (2) to create a set (L) of label histograms. A pick out part (16) performs a pick out process of picking out pieces of data (x) that are targets of a second sampling process from the data set (X) on the basis of uncertainty of information included in the label histograms. The label histogram creating part (14) performs the second sampling process on the pieces of data (x) picked out by the pick out part (16) with the number of times of sampling (β) increased compared to the number of times of sampling (β) in the first sampling process.

### CROSS-REFERENCE STATEMENT

This application is US National Stage of International Patent Application PCT/JP2022/020726, filed May 18, 2022, the disclosure of which is hereby incorporated by reference herein in its entirety.

### BACKGROUND

### Technical Field

The disclosure relates to a label histogram creating device, a label histogram creating method, and a label histogram creating program.

### Related Art

A label histogram indicates a probability distribution of possible labels for classifying certain data. The label histogram is created by a plurality of persons independently performing sampling of assigning a label to the data. Such a label histogram is generally created by using a crowdsourcing.

In the field of machine learning, there are many so-called benchmark data sets, which are sets of label histograms that have been created by performing sampling for a plurality of different pieces of data with labels of the same classifications (see, for example, Non-patent Literature 1: Yann Lecun, et al., “THE MNIST DATABASE”, [online], [Retrieved on May 6, 2022], the Internet <URL: http://yann.lecun.com/exdb/mnist/>). A benchmark data set is used for performance evaluation of a data classifier constructed through machine learning.

Such a benchmark data set is often obtained by assigning a label only once to one piece of data. That is, the number of times of sampling is one. On the other hand, it has been proposed to improve the accuracy of performance evaluation of a data classifier by increasing the number of times of sampling to increase a diversity of label histograms (see, for example, Non-patent Literature 2: Mimori, T., Sasada, K., Matsui, H., and Sato, I. (2021). “Diagnostic uncertainty calibration: Towards reliable machine predictions in medical domain”, in Proceedings of the 24th International Conference on Artificial Intelligence and Statistics, Volume 130 of Proceedings of Machine Learning Research, pages 3664-3672. PMLR.).

However, in a case where a crowdsourcing is used, monetary cost increases with increase in the number of times of sampling. Depending on pieces of data configuring a data set, even when the number of times of sampling is increased, the votes may be concentrated on a specific label in most of the pieces of data.

In such a case, it may be conceivable to discard a label histogram of a piece of data for which votes are concentrated on a specific label in order to increase diversity. However, the cost incurred to create the discarded label histogram will be wasted. That is, the number of times of sampling for pieces of data included in a final set of label histograms is smaller with respect to the cost incurred to create the set of label histograms. Thus, the product may not be worth the cost.

### SUMMARY

The disclosure provides a label histogram creating device that creates a label histogram by performing a sampling process of assigning a label for classifying a piece of data by using a crowdsourcing, the label histogram indicating a probability distribution of possible labels for the piece of data. The label histogram creating device includes the following:
a label histogram creating part configured to, for a data set including a plurality of pieces of data, set the number of times of sampling for each piece of data and perform a first sampling process by using the crowdsourcing to create a set of label histograms; and
a pick out part configured to perform a pick out process of picking out pieces of data that are targets of a second sampling process from the data set on the basis of uncertainty of information included in the label histograms.

The label histogram creating part is configured to perform, by using the crowdsourcing, the second sampling process on the pieces of data picked out by the pick out part with the number of times of sampling increased compared to the number of times of sampling in the first sampling process.

### DRAWINGS

FIG. 1 is a conceptual diagram of a label histogram creating system to which a label histogram creating device according to a present embodiment is applied.

FIG. 2 is a diagram for describing a label histogram.

FIG. 3 is a block diagram illustrating a functional configuration of a label histogram creating device.

FIG. 4 is a diagram illustrating an example of a set of label histograms.

FIG. 5 is a diagram illustrating another example of a set of label histograms.

FIG. 6 is a flowchart for describing a flow of processing of a label histogram creating device.

FIG. 7 is a flowchart for describing a flow of a sampling process after a first sampling process.

FIG. 8 is a flowchart for describing a flow of a pick out process.

FIG. 9 is a diagram illustrating an example of image data included in a data set.

FIG. 10 is a diagram illustrating an example of arrangement of pins.

FIG. 11 is a diagram illustrating an example of picked out pieces of data.

FIG. 12 is a hardware configuration diagram illustrating an example of a computer that realizes functions of the label histogram creating device according to the present embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Next, an embodiment for carrying out the disclosure (hereinafter, referred to as the “present embodiment”) will be described with reference to the drawings.

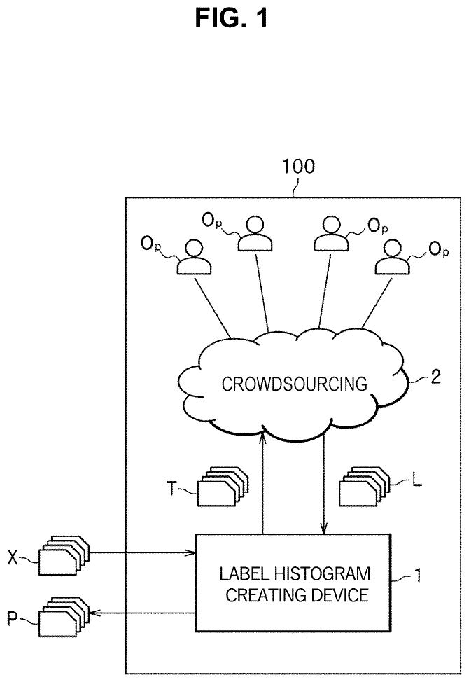

FIG. 1 is a conceptual diagram of a label histogram creating system to which a label histogram creating device according to the present embodiment is applied.

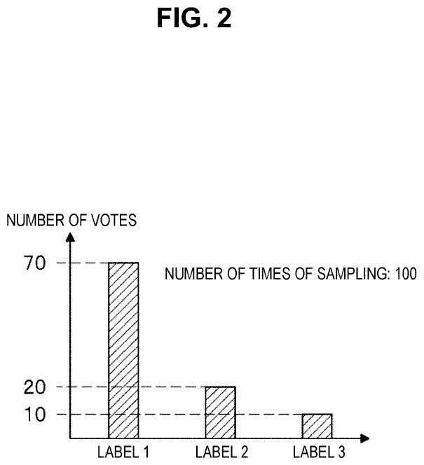

FIG. 2 is a diagram for describing a label histogram.

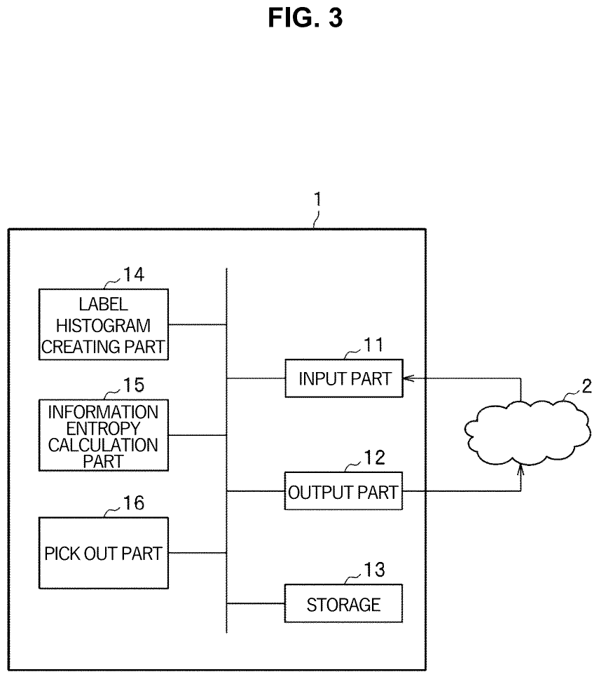

FIG. 3 is a block diagram illustrating a functional configuration of the label histogram creating device.

As illustrated in FIG. 1, a label histogram creating system 100 includes a label histogram creating device 1 and a crowdsourcing 2.

A data set X, which is a label histogram creation target, is inputted from the outside to the label histogram creating device 1. The data set X includes a plurality of pieces of data x. A piece of data x is, for example, data such as an image, a piece of audio, or a moving image, and is data used for machine learning. The pieces of data x belonging to the data set X may be classified by using the same label set Y. The label set Y includes K types of labels y as described below.

$$y ∈ Y = \{ 1 , … , K \} \qquad [ Math . 1 ]$$

The label histogram indicates a probability distribution of possible labels y in a piece of data x. In other words, x and y are probability variables sampled from a probability distribution P(x, y).

A label histogram is created by a plurality of persons independently assigning a label y to a piece of data x. An act of assigning a label y to piece of data x is referred to as sampling.

FIG. 2 illustrates an example in which 100 people perform sampling for one piece of data x. In the example, 70 people assign label 1, 20 people assign label 2, and 10 people assign label 3 to the piece of data x. In this case, a label histogram for the piece of data x is expressed as [70, 20, 10].

Here, the number of times a label y is assigned to a piece of data x to form a label histogram will be referred to as the number of times of sampling. The number of times each label y has been assigned to a piece of data x will be referred to as the number of votes. In the example shown in FIG. 2, the number of times of sampling is 100, the number of votes for label 1 is 70, the number of votes for label 2 is 20, and the number of votes for label 3 is 10.

As illustrated in FIG. 1, the label histogram creating device 1 creates a label histogram for each piece of data x of the data set X by using the crowdsourcing 2. The crowdsourcing 2 is a system for recruiting many and unspecified workers Op on the Internet and requesting a task.

The label histogram creating device 1 outputs a set T of pieces of data x that are sampling targets to the crowdsourcing 2 via a network.

A worker Op who receives a request via the crowdsourcing 2 performs sampling for each piece of data x of the set T. In the crowdsourcing 2, the numbers of votes of the workers Op are counted, and a label histogram is created for each piece of data x. A set L of label histograms, which is a collection of label histograms created for the pieces of data x of the set T, is inputted from the crowdsourcing 2 to the label histogram creating device 1.

The label histogram creating device 1 normalizes the label histograms that have been created by using the crowdsourcing 2 as described above and outputs a set P of normalized label histograms for the data set X to the outside as a final product.

As illustrated in FIG. 3, the label histogram creating device 1 includes an input part 11, an output part 12, a storage 13, a label histogram creating part 14, an information entropy calculation part 15, and a pick out part 16.

The input part 11 and the output part 12 include a communication interface and an input/output interface or the like. The communication interface transmits and receives information to and from the crowdsourcing 2 or the like via a communication network. The input/output interface inputs/outputs information from/to an input device such as a keyboard (not illustrated) or an output device such as a display (not illustrated).

The storage 13 stores therein a program (label histogram creating program) for operating each functional part of the label histogram creating device 1 and information necessary for processing of each functional part.

As an example, the storage 13 stores therein the data set X inputted from the outside. The storage 13 stores therein the set L of label histograms inputted from the crowdsourcing 2. The storage 13 stores therein a parameter or the like used for processing that will be described later.

The label histogram creating part 14 creates the set L of label histograms by performing a sampling process by using the crowdsourcing 2 as described above.

In the present embodiment, the label histogram creating part 14 performs a sampling process using the crowdsourcing 2 a plurality of times.

The label histogram creating part 14 sets the set T and the number of times of sampling β for each sampling process. As described above, the set T includes pieces of data x that are targets of a sampling process. The number of times of sampling β is the number of times of sampling for each piece of data x making up the set T. That is, in each sampling process, the label histogram creating part 14 specifies the number of times of sampling β when outputting the set T of pieces of data x that are targets of the sampling process to the crowdsourcing 2. When the set L of label histograms, the set L being a sampling result of the set T, is inputted from the crowdsourcing 2, the label histogram creating part 14 stores the set L in the storage 13.

For each sampling process, the label histogram creating part 14 changes the number of pieces of data α, which is the number of pieces of data that make up the set T, and the number of times of sampling β for each piece of data x.

More specifically, the label histogram creating part 14 performs a sampling process on all N pieces of data x included in the data set X in a first sampling process. That is, in the first sampling process, the number of pieces of data, α, is equal to N.

In a second sampling process, the label histogram creating part 14 increases the number of times of sampling β for each piece of data x as compared with the first sampling process while decreasing the number of pieces of data α that are included in the set T from N.

In a case where a sampling process after the first sampling process is performed a plurality of times, the label histogram creating part 14 increases the number of times of sampling β for each piece of data x as compared with the previous sampling process while decreasing the number of pieces of data α in the set T as compared with the previous sampling process.

That is, the label histogram creating part 14, while narrowing down pieces of data x that are to be sampling targets, performs sampling intensively for the narrowed-down pieces of data X.

The number of pieces of data α, which is the number of pieces of data that are sampling targets, and the number of times of sampling β for each piece of data x are set for each sampling process by, for example, an operator of the label histogram creating device 1 and are stored in the storage 13 as parameters. The number of times of performing the sampling process after the first sampling process, M, may similarly be set by the operator and stored in the storage 13 as a parameter.

Upon completion of the sampling process, the label histogram creating part 14 creates the set P of label histograms for the data set X by normalizing the set L of label histograms stored in the storage 13.

The information entropy calculation part 15 and the pick out part 16 perform a process for narrowing down pieces of data x that are to be sampling targets.

The information entropy calculation part 15 calculates an information entropy H of a label histogram for a piece of data x for which the label histogram has been created through a sampling process.

The information entropy H indicates uncertainty of information included in the label histogram. The more uncertain the information indicated by the label histogram is, the larger an amount of information held by the label histogram becomes. That is, if the information entropy His large, this indicates that the label histogram includes a large amount of information, and if the information entropy H is small, this indicates that the label histogram includes a small amount of information.

When the first sampling process has been performed, the information entropy calculation part 15 calculates the information entropy H for each of the label histograms of the N pieces of data x making up the data set X.

With regards to the sampling process after the first sampling process, the information entropy calculation part 15 only calculates the information entropy H for pieces of data x that are sampling targets and for which label histograms have been created.

The pick out part 16 performs a pick out process of picking out pieces of data x that are to be targets of the next sampling process on the basis of the uncertainty of information included in the label histogram of each piece of data x.

More specifically, the pick out part 16 refers to the information entropy H of the label histogram of each piece of data x that has been calculated by the information entropy calculation part 15 and picks out pieces of data x whose information entropies H are mutually dispersed.

The pick out part 16 collectively sets the picked out pieces of data x as a set T for the next sampling process.

The number of pieces of data x that are picked out by the pick out part 16 matches the number of pieces of data that are sampling targets a, which is set as a parameter for each sampling process.

That is, the pick out part 16 decreases the number of pieces of data x to be picked out each time a sampling process is performed.

Details of the pick out process of the pick out part 16 will be described later.

As described above, in the present embodiment, by narrowing down the pieces of data x that are to be sampling targets on the basis of information entropies H and concentrating the sampling for the narrowed-down pieces of data x, the diversity of label histograms in the final set P of label histograms created is enhanced while the total number of times of sampling is curbed.

The set of label histograms created by the label histogram creating device 1 is used, for example, for performance evaluation of a data classifier constructed through machine learning. Here, as the label histograms of the set become more diverse, the performance evaluation of the data classifier may be performed with higher accuracy. For example, label histograms may be described as being diverse in a case where label histograms of a set include a well-balanced mix of those having a large amount of information, those having a small amount of information, and those having a medium amount of information, so that concentration of values of the amount of information is small.

In order to increase the diversity of the label histograms, it is conceivable to increase the number of times of sampling for each piece of data x. However, even if the number of times of sampling for all pieces of data x included in the data set X is simply increased, it may not be possible to increase the diversity of label histograms.

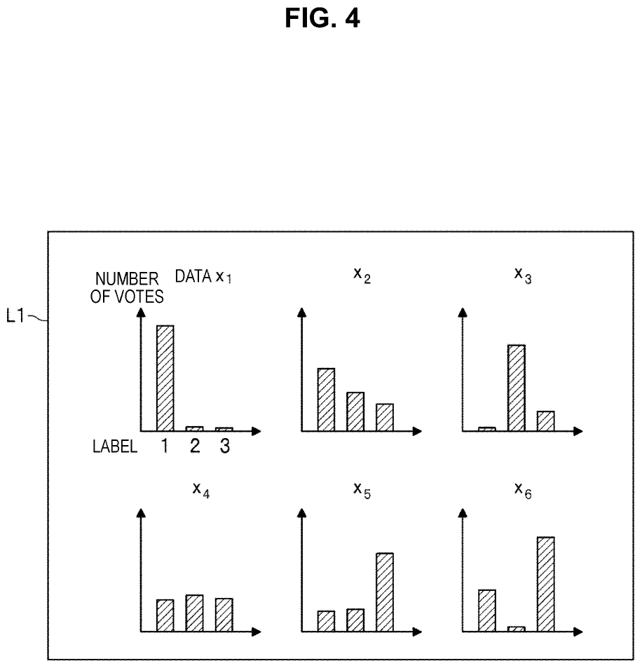

FIG. 4 is a diagram illustrating an example of a set of label histograms.

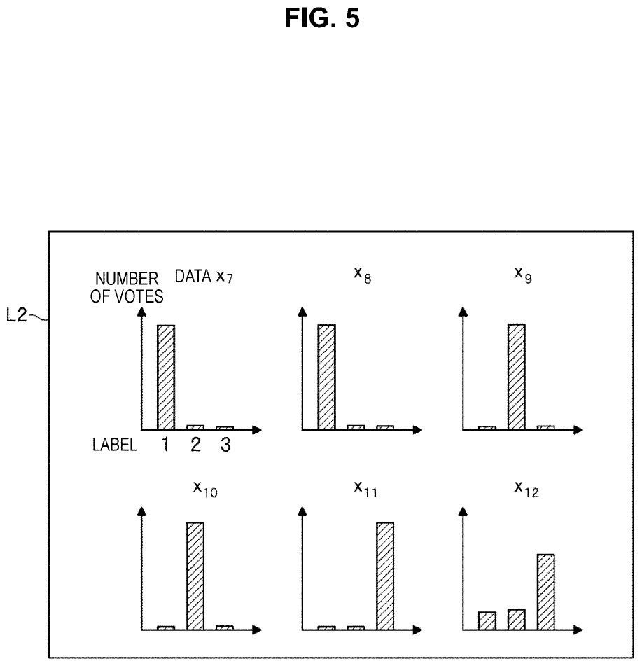

FIG. 5 is a diagram illustrating another example of a set of label histograms.

FIG. 4 illustrates an example in which a set Ll of label histograms has been created by performing sampling for a data set including six pieces of data, data x1 to x6. FIG. 5 illustrates an example in which a set L2 of label histograms has been created by performing sampling for a data set including six pieces of data, data x7 to x12. In the examples shown in FIGS. 4 and 5, the number of times of sampling is set to be the same.

For example, in the label histogram of a piece of data x1 shown in FIG. 4, votes are concentrated on label 1. It may be said that such a label histogram includes a small amount of information, that is, has a small information entropy H. In the label histogram of a piece of data x4 shown in FIG. 4, substantially the same number of votes is distributed to each of the labels 1, 2, and 3. It may be said that such a label histogram includes a large amount of information, that is, has a large information entropy H. The label histogram of a piece of data x5 shown in FIG. 4 may be said to include a medium amount of information because, even though the number of votes for label 3 is relatively large, unlike the piece of data x1, votes are not extremely concentrated on one label.

As described above, in the set L1 shown in FIG. 4, it may be said that information amounts of the label histograms of pieces of data x1 to x6 show smaller concentration of values and are mutually dispersed, and that the diversity of the label histograms is relatively high.

In FIG. 5, in the label histogram of a piece of data x12, votes are dispersed among labels 1 to 3 to some extent. However, in each of the label histograms of pieces of data x7 to x11, votes are concentrated on one label. That is, it may be said that the set L2 is occupied mostly by pieces of data whose label histograms have small information amounts, and so information amounts of the label histograms show a large concentration of values and diversity of the label histograms is relatively low.

Although, as described above, the set L2 of FIG. 5 has a lower diversity of label histograms than the set L1 of FIG. 4, since the set L2 is created with the same number of times of sampling as the set L1, the cost of using the crowdsourcing 2 is the same as that for the set L1.

Here, in order to increase the diversity of the set L2 of FIG. 5, it may be conceivable to discard, from the set L2, a part of the label histograms of pieces of data x7 to x11 in which the votes are concentrated on one label. However, in this case, the cost incurred for sampling for the discarded label histogram will be wasted. That is, the number of times of sampling for pieces of data included in the final set L2 to be outputted will be small with respect to a total cost incurred to create the set L2, and there is a possibility that the product will not be worth the cost.

The label histogram creating device of the present embodiment, on the other hand, narrows down the pieces of data x that are to be sampling targets on the basis of the information entropies H and performs sampling intensively with an increased number of times of sampling for the narrowed-down pieces of data x.

That is, in the first sampling process, the label histogram creating part 14 performs sampling for all of the N pieces of data x included in the data set X, but with the number of times of sampling β set small.

Then, from the label histograms obtained in the first sampling process, the pick out part 16 picks out a combination of pieces of data x that are very diverse on the basis of the information entropies H. The second sampling process is performed on the picked-out pieces of data x with an increased number of times of sampling β.

As a result, the number of times of sampling may be curbed to a minimum for pieces of data x whose information amount is biased and from which diversity may not easily be enhanced even if the number of times of sampling is increased. The cost may therefore be reduced.

In the present embodiment, in a case where a sampling process after the first sampling process is performed a plurality of times, each time the sampling process is performed, the number of pieces of data α that are to be targets of the next sampling process is decreased and the number of sampling β is increased. As a result, the present embodiment may further narrow down pieces of data x to a combination of pieces of data x that are highly diverse and perform sampling in a focused manner.

Processing of the label histogram creating device 1 according to the present embodiment will be described with reference to a flowchart.

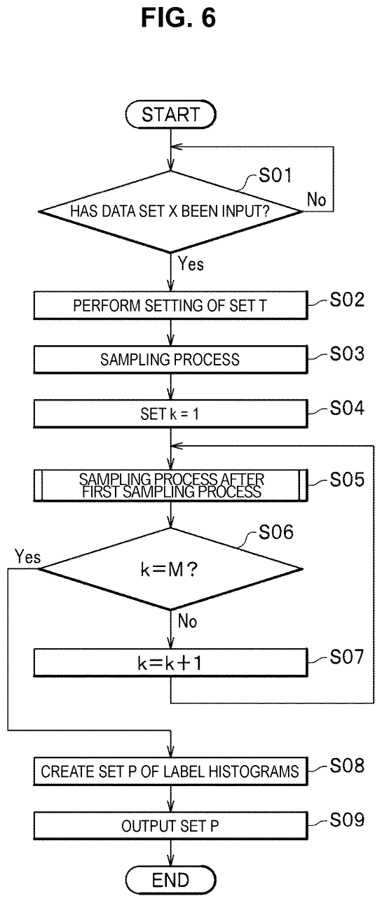

FIG. 6 is a flowchart illustrating a flow of processing of the label histogram creating device.

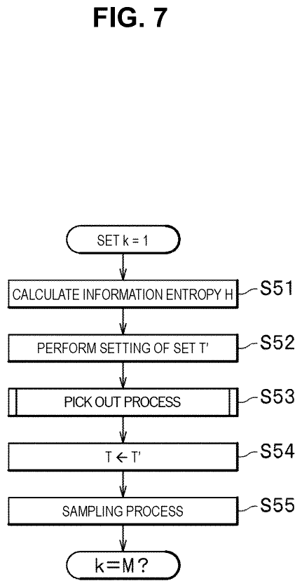

FIG. 7 is a flowchart for describing a flow of a sampling process after the first sampling process.

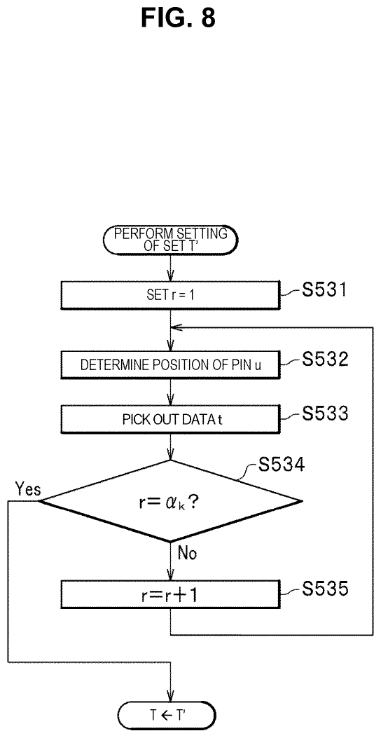

FIG. 8 is a flowchart illustrating a flow of a pick out process.

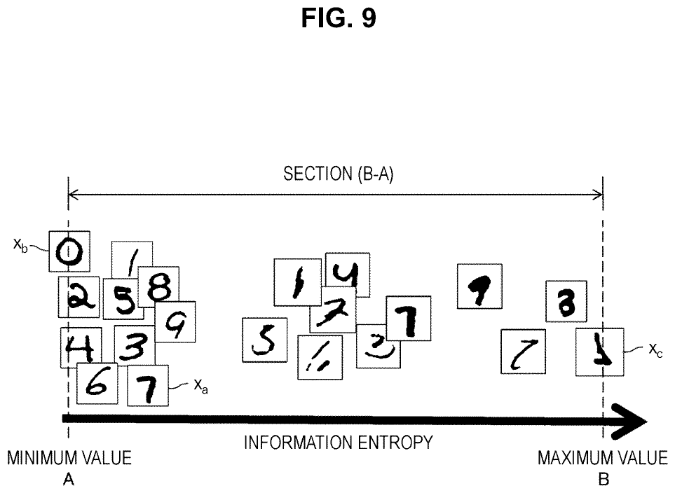

FIG. 9 is a diagram illustrating an example of pieces of data included in a data set. In FIG. 9, as an example, a plurality of pieces of image data included in the data set are disposed according to information entropies of corresponding label histograms.

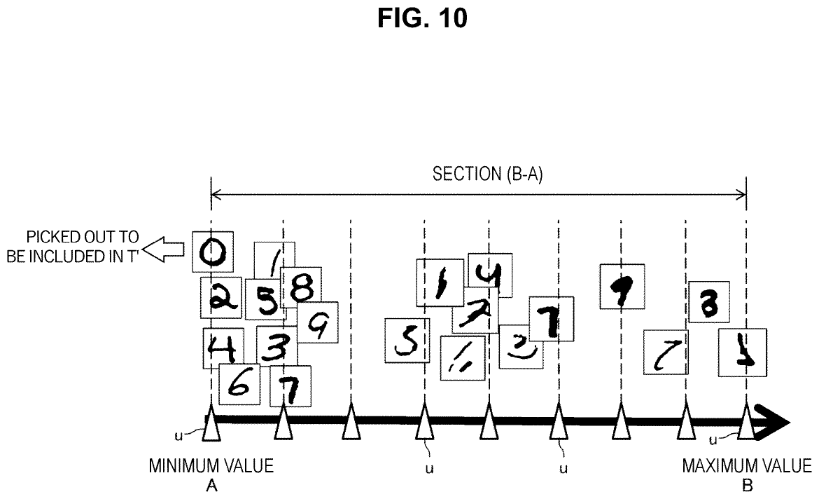

FIG. 10 is a diagram illustrating an example of arrangement of pins.

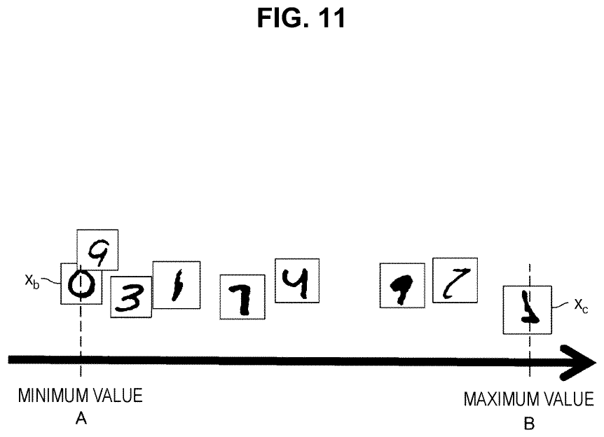

FIG. 11 is a diagram illustrating an example of picked-out pieces of data.

As illustrated in FIG. 6, when a data set X that is a target of creation of label histograms is inputted (step S01: Yes), the label histogram creating device 1 starts the processing. The label histogram creating part 14 stores the data set X inputted via the input part 11 in the storage 13. When the data set X is not inputted (step S01: No), the label histogram creating device 1 waits until the data set X is inputted.

Parameters are set as follows by an operator of the label histogram creating device 1 in accordance with the inputted data set X.

Number of pieces of data that are targets of a sampling process:

$$α = ( {α}_{1} , … , {α}_{M} ) ∈ \qquad [ Math . 2 ]$$

Number of times of sampling for each piece of data x in each sampling process:

$$β = ( {β}_{0} , {β}_{1} , … , {β}_{M} ) ∈$$

Here, M is the number of sampling processes after the first sample process.

By setting the above parameters, each time a sampling process is performed, the number of pieces of data that are sampling targets α decreases and the number of times of sampling β for each piece of data x increases.

The label histogram creating part 14 sets a set T of pieces of data x that are targets of a sampling process (step S02).

In a first sampling process, the set T includes all of the N pieces of data x that make up the data set X as described below.

$$T ← \{ 1 , … , N \} \qquad [ Math . 3 ]$$

The label histogram creating part 14 performs the first sampling process on the set T by using the crowdsourcing 2 to create a set L of label histograms (step S03).

More specifically, the label histogram creating part 14 sets the number of times of sampling β on the basis of the parameters and outputs the set T of pieces of data x to the crowdsourcing 2.

In the crowdsourcing 2, sampling is performed by workers Op, whose number corresponds to the number of times of sampling β, for each piece of data x included in the set T.

A worker Op assigns one of K types of labels y included in a label set Y to a piece of data x.

FIG. 9 illustrates, as an example, an example in which the data set X includes pieces of data x that are images of handwritten numerals provided in the MNIST database of Non-patent Literature 1.

Any one of ten types of labels of 0 to 9 is assigned to each of these pieces of data x. For example, in a case where the first number of times of sampling β is set to ten, ten workers Op assign a label y to each piece of data x.

In the crowdsourcing 2, the number of votes for the label y assigned by the workers Op is counted for each piece of data x, and a label histogram is created.

A label histogram li of a piece of data xi included in the set T is expressed by the following Expression (1).

$$[ Math . 4 ]$$

$${l}_{i} = ( {l}_{i , 1} , … , {l}_{i , K} ) ∈ \qquad ( 1 )$$

Here, an operation in which sampling is performed by a plurality of workers Op for one piece of data xi by using the crowdsourcing 2 may be regarded as a function and expressed as Sampling.

In this case, the label histogram li, which is created with the number of times of sampling β for the piece of data xi, and the set L of label histograms, which is a set of the label histograms li, may be expressed by the following Expressions (2) and (3).

$$[ Math . 5 ]$$

$${l}_{i} = Sampling ( {x}_{i} , β ) \qquad ( 2 )$$

$$L = {\{ {l}_{i} \}}_{í = 1}^{N} \qquad ( 3 )$$

For example, when sampling is performed on a piece of data xa shown in FIG. 9 with the number of times of sampling set to 10, if seven people vote for 1 and three people vote for 7, a label histogram of the image data xa is represented as [0, 7, 0, 0, 0, 0, 0, 3, 0, 0].

The crowdsourcing 2 inputs the set L of label histograms created for the set T to the input part 11 of the label histogram creating device 1.

The label histogram creating part 14 stores the set L, which is a set of label histograms of the set T, inputted from the crowdsourcing 2 in the storage 13, and thus the first sampling process is completed.

As illustrated in FIG. 6, the label histogram creating part 14 sets k, the number of sampling processes after the first sampling process, to 1 (step S04). Here, k is a natural number in a range from 1 to M. That is, the label histogram creating part 14 repeatedly performs the sampling process until k, the number of sampling processes after the first sampling process, becomes M.

The label histogram creating part 14 performs a sampling process after the first sampling process (step S05).

In the sampling process after the first sampling process, the label histogram creating part 14 performs the sampling process on pieces of data x that have been narrowed down through processes of the information entropy calculation part 15 and the pick out part 16.

As illustrated in FIG. 7, the information entropy calculation part 15 calculates the information entropy H of the label histogram li of each piece of data xi by using the set L of label histograms created through the first sampling process (step S51).

More specifically, the information entropy calculation part 15 may calculate the information entropy H from the label histogram li according to, for example, the following method.

$$[ Math . 6 ]$$

$${Δ}_{K} = {\{ ( {p}_{1} , … , {p}_{K} ) ∈ \} [ 0 , 1 ]}^{K} \vert {\sum }_{k = 1}^{K} {p}_{k} = 1 \} \qquad ( 4 )$$

In a case where a space of a K-dimensional probability vector is represented by Δ_{K}, Δ_{K} is expressed by the following Expression (4).

Here, p is a normalized label histogram, that is, a probability vector of assignment to each label for a piece of data xi, and is expressed by the following Expression (5).

$${p}_{i} = ( {p}_{i , 1} , … , {p}_{i , K} ) ∈ {Δ}_{K} \qquad ( 5 )$$

Here, in a case where a function for normalizing a label histogram is represented by S, the function S is expressed by the following Expression (6).

$$S ( {l}_{i} ) = {l}_{i} / {\sum }_{j = 1}^{K} {l}_{i , j} = {p}_{i} \qquad ( 6 )$$

Thus, the set P of the normalized label histograms is expressed by the following Expression (7).

$$P = {\{ {p}_{i} \}}_{i = 1}^{N} \qquad ( 7 )$$

Here, in a case where a function for calculating an information entropy is represented by H, the information entropy H of a piece of data xᵢ is expressed by the following Expression (8).

$$H ( {p}_{i} ) = - {\sum }_{k = 1}^{K} {p}_{i , k} {log}_{2} {p}_{i , k} \qquad ( 8 )$$

Note that the function H related to the uncertainty of information included in the label histogram is not limited to the information entropy and may, for example, be calculated by using the following Expression (9) or (10).

$$[ Math . 7 ]$$

$$\cdot H ( {p}_{i} ) = 1 - {max}_{k ∈ \{ 1 , … , K \}} {p}_{i , k} \qquad ( 9 )$$

$$\cdot H ( {p}_{i} ) = \frac{1}{{max}_{k ∈ \{ 1 , … , K \} {p}_{i , k}}} \qquad ( 10 )$$

The pick out part 16 sets a set T′ of pieces of data x that are targets of the next sampling process (step S52).

The pick out part 16 sets a minimum value A and a maximum value B of the set T′ as described below. More specifically, the pick out part 16 extracts the minimum value A and the maximum value B from the respective information entropies H of the pieces of data x that have been calculated by the information entropy calculation part 15.

$${T}^{′} ← \{ \} \qquad [ Math . 8 ]$$

$$A ← {min}_{i ∈ T} H ∘ S ( {l}_{i} )$$

$$B ← {max}_{i ∈ T} H ∘ S ( {l}_{i} )$$

In the example shown in FIG. 9, pieces of image data x included in the data set X are disposed according to the magnitude of the information entropy H of each label histogram. The information entropy H of a piece of data xb is the minimum value A, and the information entropy H of a piece of data xc is the maximum value B. All the pieces of data x are located within a section (B-A) between the minimum value A and the maximum value B. As is clear from FIG. 9, a piece of image data x of a character that is easy to distinguish, that is, a piece of image data x of a character having a low level of classification difficulty, has a small information entropy H. A piece of image data x of a character that is difficult to distinguish, that is, a piece of image data x of a character having a high level of classification difficulty, has a large information entropy H.

As illustrated in FIG. 7, the pick out part 16 performs a pick out process of picking out pieces of data x that become targets of the next sampling process to form the set T′ (step S53).

As illustrated in FIG. 9, the pieces of data x are not evenly distributed across the section (B-A), but are located with clusters forming around the minimum value A, around the center, and around the maximum value B. From these pieces of data x, the pick out part 16 picks out a combination of pieces data whose information entropies H are mutually dispersed.

As illustrated in FIG. 10, the pick out part 16 divides the section (B-A) into subsections with divisions at equal intervals, and arranges pins u at positions that form boundaries of respective subsections. The positions where the pins u are arranged include the minimum value A and the maximum value B. The number of pins u that are arranged is equal to the number of pieces of data α that are targets of the next sampling process. For example, when α=9, the pick out part 16 divides the section (B-A) equally into eight parts and arranges nine pins u.

Further, the pick out part 16 sequentially picks out a piece of data x having an information entropy H that is closest to each pin u and adds the piece of data x to the set T′.

As illustrated in FIG. 11, nine pieces of data x including the pieces of data xb and xc having the minimum value A and the maximum value B are picked out and included in the set T′ through the pick out process. With the picked out pieces of data x, information entropies H show relatively low concentration of values, and there is a well-balanced combination of pieces of data having a low level of classification difficulty, pieces of data having a medium level of classification difficulty, and pieces of data having a high level of classification difficulty.

That is, even for a data set X having an uneven distribution of information entropies H as illustrated in FIG. 9, it is possible to obtain a combination of pieces of data x whose label histograms are highly diverse and whose information entropies H are mutually dispersed as illustrated in FIG. 11 through the pick out process of the present embodiment.

More specifically, as illustrated in FIG. 8, the pick out part 16 sets r to 1, where r is the number of times of picking out a piece of data x for the set T′ (step S531). Here, r is a natural number between 1 and αk. αk is the number of pieces of data that are to be targets of the next sampling process as set by the parameters.

The pick out part 16 determines a position of a pin u by using the following Expression (11) (step S532).

$$[ Math . 9 ]$$

$$u ← A + \frac{( r - 1 ) ( B - A )}{{α}_{k} - 1} \qquad ( 11 )$$

In accordance with the above Expression (11), positions of the pins u are determined in order from a side of the minimum value A, that is, from a side with the smaller information entropy H.

That is, a pin u is determined to be the minimum value A in the 1st time of picking out a piece of data, and a pin u is determined to be the maximum value B in the αk-th time of picking out a piece of data.

The pick out part 16 picks out a piece of data t having an information entropy H that is closest to a determined pin u to be included in the set T′ (step S533).

The pick out part 16 identifies the piece of data t having an information entropy H that is closest to a pin u by using, for example, the following Expression (12).

$$[ Math . 10 ]$$

$$t ← arg {min}_{i ∈ T} ‖ u - H ∘ S ( {l}_{i} ) ‖ \qquad ( 12 )$$

The pick out part 16 further causes the piece of data t to be included in the new set T′ and excluded from the original set T by using the following Expressions (13).

$$[ Math . 11 ]$$

$${T}^{′} ← {T}^{′} ⋃ \{ t \} \qquad ( 13 )$$

$$T ← T \backslash \{ t \}$$

If r, the number of times of picking out a piece of data, is not equal to αk (step S534: No), the pick out part 16 sets r=r+1 (step S535) and returns to steps S532 and S533 to determine the next pin u, pick out a piece of data t closest to the pin u, and include the piece of data t in the set T′in a sequential manner.

If r, the number of times of picking out a piece of data, is equal to αk (step S534: Yes), the pick out part 16 ends the pick out process.

Returning to FIG. 7, the pick out part 16 overwrites the original set T with the set T′ that includes the picked-out pieces of data t (step S54). As a result, the set T is updated to a set that includes only the pieces of data x that are targets of the next sampling process.

The label histogram creating part 14 uses the crowdsourcing 2 to perform a sampling process on the set T that has been newly set (step S55).

More specifically, the label histogram creating part 14 sets the number of times of sampling βk and outputs the pieces of data x included in the set T to the crowdsourcing 2. Here, the label histogram creating part 14 increases the number of times of sampling βk from the number of times of sampling β in the first sampling process on the basis of the set parameters. As described above, the set T updated through the pick out process includes a combination of pieces of data x having a highly diverse label histograms. By increasing the number of times of sampling βk for this combination, the diversity of label histograms of these pieces of data x may be further enhanced.

In the crowdsourcing 2, a label histogram is created by performing sampling for a piece of data xi that is a target of the second sampling process in the same manner as in the first sampling process, and the created label histogram is inputted to the input part 11 of the label histogram creating device 1.

The storage 13 stores therein a label histogram li of the piece of data xi that has been created in the first sampling process.

The label histogram creating part 14 adds the label histogram created in the second sampling process to the label histogram li of the piece of data xi created in the first sampling process and stores the label histogram li as expressed by the following Expression (14).

$$[ Math . 12 ]$$

$${l}_{i} ← {l}_{i} + Sampling ( {x}_{i} , {β}_{k} ) \qquad ( 14 )$$

As illustrated in FIG. 6, if the number of sampling processes after the first sampling process k is not equal to M (step S06: No), the label histogram creating part 14 sets k=k+1 (step S07), returns to step S05, and performs another sampling process.

Each time the sampling process is performed, the number of pieces of data αk that is the number of pieces of data that are targets of the next sampling process is narrowed down compared to the previous sampling process through the pick out process of the information entropy calculation part 15 and the pick out part 16. The label histogram creating part 14 performs sampling for the narrowed-down pieces of data x with the number of times of sampling βk increased compared with that in the previous sampling process.

As an example, the label histogram creating device 1 may perform processing as follows.

For example, in a case where a data set X that includes 10,000 pieces of data x is inputted, the label histogram creating part 14 performs sampling for the 10,000 pieces of data x in the first sampling process by setting the number of times of sampling β for each piece of data x to 10.

The pick out part 16 performs a pick out process using label histograms of the 10,000 pieces of data x to narrow down the number of pieces of data α, which is the number of pieces of data that are the next sampling targets, to 1,000.

In the second sampling process, the label histogram creating part 14 performs sampling for the 1,000 pieces of data x with the number of times of sampling β for each piece of data x increased to 90.

The pick out part 16 performs a pick out process using label histograms of the 1,000 pieces of data x to narrow down the number of pieces of data α, which is the number of pieces of data that are the next sampling targets, to 200.

The label histogram creating part 14 performs sampling for the 200 pieces of data x with the number of times of sampling β for each piece of data x increased to 9900.

By repeating the narrowing down of pieces of data x and the increasing of the number of times of sampling β as described above, the sampling process is intensively performed on a combination of pieces of data x having high diversity of label histograms. Therefore, it may be possible to create a set L of label histograms having high diversity from a data set X while curbing the number of times of sampling for data set X as a whole.

As illustrated in FIG. 6, when the number of sampling processes after the first sampling process k is equal to M (step S06: Yes), the label histogram creating part 14 ends the sampling process. The label histogram creating part 14 normalizes the label histograms li of the pieces of data x included in the data set X stored in the storage 13 according to the following Expression (15) to create a set P of label histograms for the data set X (step S07).

$$[ Math . 13 ]$$

$$P ← {\{ S ( {l}_{í} ) \}}_{i = 1}^{N} \qquad ( 15 )$$

The label histogram creating part 14 outputs the set P of normalized label histograms for the data set X to the outside via the output part 12 (step S08) and ends the processing.

### Hardware Configuration

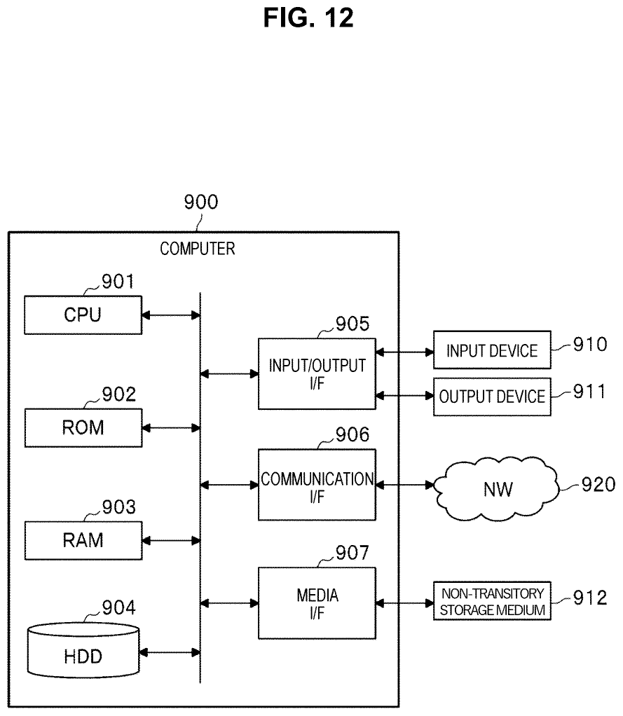

The label histogram creating device 1 according to the present embodiment is implemented by, for example, a computer 900 as shown in FIG. 12.

FIG. 12 is a hardware configuration diagram illustrating an example of a computer 900 that realizes functions of the label histogram creating device 1 according to the present embodiment.

The computer 900 includes a central processing unit (CPU) 901, a read only memory (ROM) 902, a random access memory (RAM) 903, a hard disk drive (HDD) 904, an input/output interface (I/F) 905, a communication I/F 906, and a media I/F 907.

The CPU 901 operates on the basis of a program (label histogram creating program) stored in the ROM 902 or the HDD 904 and performs processing of each functional part of the label histogram creating device 1 illustrated in FIG. 3. The ROM 902 stores therein a boot program to be executed by the CPU 901 when the computer 900 is started, a program related to hardware of the computer 900, or the like.

The CPU 901 controls an input device 910, such as a mouse or a keyboard, and an output device 911, such as a display, via the input/output I/F 905. The CPU 901 obtains data from the input device 910 and outputs generated data to the output device 911 via the input/output I/F 905. Note that a graphics processing unit (GPU) or the like may be used as a processor together with the CPU 901.

The HDD 904 stores therein a program to be executed by the CPU 901 and data to be used by the program or the like. The communication I/F 906 receives data from the crowdsourcing 2 (see FIG. 1) or another device via a communication network (for example, a network [NW] 920) and outputs the data to the CPU 901, and transmits data generated by the CPU 901.

The media I/F 907 reads a program or data stored in a non-transitory storage medium 912 and outputs the program or data to the CPU 901 via the RAM 903. The CPU 901 loads a program related to target processing from the non-transitory storage medium 912 and into the RAM 903 via the media I/F 907 and executes the loaded program. The non-transitory storage medium 912 is an optical recording medium such as a digital versatile disc (DVD) or a phase change rewritable disk (PD), a magneto-optic recording medium such as a magneto optical disk (MO), a magnetic recording medium, a conductor memory tape medium, a semiconductor memory, or the like.

For example, when the computer 900 functions as the label histogram creating device 1 according to the present embodiment, the CPU 901 of the computer 900 realizes the functions of the label histogram creating device 1 by executing a program loaded onto the RAM 903. Further, the HDD 904 stores therein data in the RAM 903. The CPU 901 reads a program related to target processing from the non-transitory storage medium 912 and executes the program. In one or more embodiments, the CPU 901 may read a program related to target processing from another device via the communication network (NW 920).

### Configuration of Above Embodiment and Operational Effects Thereof

(1) The label histogram creating device 1 creates a label histogram indicating a probability distribution of possible labels y in a piece of data x by performing a sampling process of assigning a label y for classifying the piece of data x by using the crowdsourcing 2. The crowdsourcing 2 is a system in which the sampling process requested by the label histogram creating device 1 is performed by many and unspecified workers Op recruited on the Internet.

The label histogram creating device 1 includes a label histogram creating part 14 and a pick out part 16.

The label histogram creating part 14 sets the number of times of sampling β for each piece of data x for a data set X including N (a plurality of) pieces of data x, performs a first sampling process by using the crowdsourcing 2, and creates a set L of label histograms.

The pick out part 16 performs a pick out process of picking out pieces of data x that are to be targets of a second sampling process from the data set X on the basis of uncertainty of information included in the label histogram.

The label histogram creating part 14 performs, by using the crowdsourcing 2, the second sampling process on the pieces of data x picked out by the pick out part 16 with the number of times of sampling β increased compared to the number of times of sampling β in the first sampling process.

With such a configuration, the label histogram creating device 1 may create a set L of label histograms that are highly diverse while reducing cost.

More specifically, by performing the pick out process on the basis of uncertainty of information (for example, the information entropy H) included in the label histograms, the pick out part 16 may narrow down targets of the next sampling process to a combination of highly diverse pieces of data x whose label histograms include amounts of information that are varied. By performing the sampling process on the narrowed-down pieces of data x with an increased number of times of sampling β, it may be possible to further increase the diversity of the label histograms of the pieces of data x.

Further, because the number of times of sampling β may be set to be low in the first sampling process in which sampling is performed for all pieces of data x in the data set X, a total number of times of sampling may be reduced, thus reducing the cost of using the crowdsourcing 2.

(2) After the first sampling process, the label histogram creating part 14 performs the sampling process M times (a plurality of times) by using the crowdsourcing 2.

Each time the sampling process is performed, the pick out part 16 performs a pick out process of picking out pieces of data x that are targets of a next sampling process with the number of times of picking out a piece of data decreased compared to the number of times of picking out a piece of data for a previous sampling process.

The label histogram creating part 14 performs the next sampling process on the pieces of data x picked out by the pick out part 16 with the number of times of sampling β increased compared to the number of times of sampling β in the previous sampling process.

As the number of times of sampling β increases, the diversity of label histograms increases, but the cost of using the crowdsourcing 2 increases as well. Therefore, each time the sampling process is performed, the label histogram creating device 1 of the present embodiment further narrows down the number of pieces of data α, that is the number of pieces of data that are sampling targets, and gradually increases the number of times of sampling β, that is the number of times of sampling for each piece of data x. As a result, it may be possible to intensively perform sampling for combinations of pieces of data x that are highly diverse and to further increase diversity while reducing an increase in cost.

(3) The label histogram creating device 1 includes an information entropy calculation part 15.

The information entropy calculation part 15 calculates an information entropy H of a label histogram for a piece of data x for which the label histogram has been created through the sampling process.

By calculating the information entropy H that indicates the uncertainty of information included in the label histogram, the pick out part 16 may narrow down the pieces of data x based on the information entropy H. As a result, the pick out part 16 may select a combination of pieces of data x whose label histograms are highly diverse.

(4) The pick out part 16 picks out pieces of data x whose the information entropies H are dispersed from each other as the pick out process.

Because the pick out part 16 picks out pieces of data x whose information entropies H are mutually dispersed, it may be possible to select a combination of highly diverse pieces of data x with information entropies H that are not clustered together as the next sampling target.

(5) As the pick out process, the pick out part 16 divides a section (B-A) between a minimum value A and a maximum value B of the information entropies H into subsections according to the number of pieces of data x to be picked out, and picks out a piece of data x including an information entropy H that is closest to a pin u indicating a boundary position of each subsection.

As a result, the pick out part 16 may pick out a well-balanced combination of pieces of data x whose information entropies H are mutually dispersed in accordance with the number of pieces of data α that is the number of pieces of data that are targets of the next sampling process. For example, the pick out part 16 may pick out pieces of data x that form a more well-balanced combination by dividing the section (B-A) into subsections whose boundaries are equally spaced apart when arranging the pins u.

The above-described effects may also be applicable to a label histogram creating method performed by the label histogram creating device 1 and a label histogram creating program for causing a computer 900 to function as the label histogram creating device 1.

Note that the disclosure is not limited to the above-described embodiment, and many modifications may be made by those skilled in the art within the technical idea of the disclosure.

An object of a label histogram creating device is to create a highly diverse set of label histograms while reducing cost.

According to the disclosure, it is possible to create a highly diverse set of label histograms while reducing cost.

### REFERENCE SIGNS LIST

1 Label histogram creating device
2 Crowdsourcing
11 Input part
12 Output part
13 Storage
14 Label histogram creating part
15 Information entropy calculation part
16 Pick out part
100 Label histogram creating system
Op Worker

1. A label histogram creating device that creates a label histogram by performing a sampling process of assigning a label for classifying a piece of data by using a crowdsourcing, the label histogram indicating a probability distribution of possible labels for the piece of data, the label histogram creating device comprising a hardware processor configured to,
for a data set including a plurality of pieces of data, set the number of times of sampling for each piece of data αnd perform a first sampling process by using the crowdsourcing to create a set of label histograms,
perform a pick out process of picking out pieces of data that are targets of a second sampling process from the data set on the basis of uncertainty of information included in the label histograms, and
perform, by using the crowdsourcing, the second sampling process on the pieces of data picked out by the pick out part process with the number of times of sampling increased compared to the number of times of sampling in the first sampling process.

2. The label histogram creating device according to claim 1, wherein
the hardware processor is configured to
perform a sampling process a plurality of times by using the crowdsourcing after the first sampling process, and.
each time the sampling process is performed, perform a pick out process of picking out pieces of data that are targets of a next sampling process with the number of times of picking out a piece of data reduced compared to the number of times of picking out a piece of data for a previous sampling process, and
the hardware processor is configured to perform the next sampling process on the pieces of data picked out by the pick out process with the number of times of sampling increased compared to the number of times of sampling in the previous sampling process.

3. The label histogram creating device according to claim 1, wherein the hardware processor is configured to calculate, for a piece of data for which the label histogram has been created through the sampling process, an information entropy of the label histogram.

4. The label histogram creating device according to claim 3, wherein the hardware processor is configured to pick out, as the pick out process, pieces of data whose information entropies are dispersed from one another.

5. The label histogram creating device according to claim 4, wherein,
as the pick out process, the hardware processor is configured to: divide a section between a minimum value and a maximum value of the information entropies into subsections according to the number of pieces of data to be picked out; and pick out a piece of data including an information entropy that is closest to a boundary position of each subsection.

6. A label histogram creating method for a label histogram creating device that creates a label histogram by performing a sampling process of assigning a label for classifying a piece of data by using a crowdsourcing, the label histogram indicating a probability distribution of possible labels in the piece of data,
the label histogram creating method comprising:
setting the number of times of sampling for each piece of data for a data set including a plurality of pieces of data and performing a first sampling process on the data set by using the crowdsourcing to create a set of label histograms;
performing a pick out process of picking out pieces of data that are targets of a second sampling process from the data set on the basis of uncertainty of information included in the label histograms; and
performing, by using the crowdsourcing, the second sampling process on the pieces of data picked out by the pick out process with the number of times of sampling increased compared to the number of times of sampling in the first sampling process.

7. A non-transitory storage medium storing a label histogram creating program for causing a computer to function as a label histogram creating device that creates a label histogram by performing a sampling process of assigning a label for classifying a piece of data by using a crowdsourcing, the label histogram indicating a probability distribution of possible labels for the piece of data, the program causing the computer to:
set the number of times of sampling for each piece of data for a data set including a plurality of pieces of data αnd perform a first sampling process on the data set by using the crowdsourcing to create a set of label histograms;
perform a pick out process of picking out pieces of data that are targets of a second sampling process from the data set on the basis of uncertainty of information included in the label histograms; and
perform, by using the crowdsourcing, the second sampling process on the pieces of data picked out by the pick out process with the number of times of sampling increased compared to the number of times of sampling in the first sampling process
